(19) United States
(12) Patent Application Publication
(10) Pub. No.: US 2017/0132705 A1
(43) Pub. Date: May 11, 2017

(54) SYSTEM AND METHOD FOR AGGREGATING FINANCIAL DATA

(71) Applicant: PGMtech Solutions, LLC, New York, NY (US)

(72) Inventors: Vidya Anakru, Parsippany, NJ (US); Pavitra Anakru, Parsippany, NJ (US); Nate Jackson, Chicago, IL (US); William Sexton, Goldens Bridge, NY (US); John Johnston, Morristown, NJ (US); Stephen Grady, Freehold, NJ (US)

(21) Appl. No.: 14/934,693

(22) Filed: Nov. 6, 2015

(51) Int. Cl. G06Q 40/06; G06Q 40/04

(52) U.S. Cl. CPC G06Q 40/06; G06Q 40/04

(57) ABSTRACT

A system for aggregating financial and post trade data that features memory that stores computer-executable instructions; a processor, communicatively coupled to the memory that facilitates execution of the computer-executable instructions that provide for a transformation engine that is adapted and configured to transform said financial and post trade data into information; and a computation engine, that is configured to compute a realized profit and loss statistic from purchase and sale data; and a plurality of databases; and a reporting engine; that is configured to create a plurality of reports according to a report configuration and report filter definition table; and an aggregation engine that is configured to collect financial and post trade data from a plurality of entities and which transforms financial and post trade data from a plurality of entities into a consolidated view of client positions and transactional activity.

### CLAIM OF PRIORITY

This application does not claim priority to any patent or patent application.

### FIELD OF THE EMBODIMENTS

The present invention and its embodiments relate to a system and method for aggregating financial data. In particular, the present invention and its embodiments relate to a system and method for aggregating financial data that is optimized to be accessed and manipulated by a human.

### BACKGROUND OF THE EMBODIMENTS

In today's world, people engage in all manner of financial transactions, involving different brokers and execution venues, different financial instruments, and currencies, and different interest rates, among many other things. However, due to the complexity of these transactions, an individual must maintain a variety of services merely to have a high-level view of their financial transactions. Further, due to the lack of aggregated information, it can be very difficult to obtain consolidated view of information such that you may engage in portfolio reconciliation, valuation and analysis, and trading. As such, there remains a need for a device that allows a person to aggregate all their financial information, and provide information in substantially real-time so that a person may know their consolidated financial position and make appropriate analysis and trading decisions.

Various devices are known in the art. However, their structure and means of operation are substantially different from the present invention. At least one embodiment of this invention is presented in the drawings below, and will be described in more detail herein. U.S. Pat. No. 7,676,406 pertains to a guaranteed physical delivery futures contract and method and system for consolidating same are disclosed. The method includes guaranteeing physical delivery for future positions of market participants having open first-nearby time positions of a particular size, making additions to or subtractions from open first-nearby time positions of market participants that are less than the particular size and offsetting the additions to and subtractions from market participants' open first-nearby time positions with opposite positions in a second-nearby time. The system includes one or more servers and communications links, the communications links for receiving position data, including open positions, and the servers are configured to make additions to or subtractions from open first-nearby time positions less than a certain size and adjust market participant second-nearby time positions based on the additions to or subtractions from open first-nearby time positions. In certain embodiments, the underlying commodity is crude oil and the particular size is the size of a cargo shipment, about 600,000 barrels.

U.S. Pat. No. 8,010,442 pertains to a system to process financial articles of trade, real time data is collected from a plurality of liquidity destinations in trading at least one of securities, commodities, options, futures and derivatives, the real time data including information on submitted transactions of financial articles of trade. The real time data collected from the plurality of liquidity destinations is aggregated. The real time data is streamed in a standardized form. User criteria are established to identify relevant portions of the streamed real time data. The streamed real time data is analyzed according to the user criteria. The analyzed real time data is consolidated into a computer data base.

U.S. Pat. No. 8,489,496 pertains to process financial articles of trade and manage risk, data messages originating from a plurality of sources arranged to trade at least one of securities, commodities, options, futures and derivatives are collected. The collected data including information on submitted transactions and completed transactions of financial articles of trade. The collected data is analyzed against established user criteria to identify select portions of the collected data. If a match is detected a risk alert signal will be transmitted.

U.S. Pat. No. 6,278,982 pertains to a securities trading consolidation system where each customer uses a single trader terminal to view, and analyze security market information from and to conduct security transactions with two or more ECNs, or other comparable ATSs, alone or in combination with one or more electronic exchanges. A consolidating computer system supplies the market information and processes the transactions. The consolidating computer system aggregates order book information from each participating ECN order book computer including security, order identification, and bid/ask prices information. Bid and ask prices for participating electronic exchanges may be integrated into the display. The combined information is displayed to a customer by security and by bids and offers, and then sorted by price, volume and other available attributes as desired by the customer. The consolidating computer system forwards to each trading terminal information from only those market maker ECNs and electronic exchanges that the customer is an ECN member or electronic exchange user and thus entitled to receive.

U.S. Pat. No. 8,543,490 pertains to a method and system for an electronic commodities trading marketplace along with ancillary tools provide an electronic trading center for world market commodity importers, exporters, and the intermediaries and processors between them. This trading center is offered through its website centered around a 24-hour exchange that provides trading markets for commodities such as coffee, sugar, cocoa and cotton. The scalable system provides aggregated third party services linked to both front and back office operations. These services can include items such as live futures quotes and real-time news, futures brokerage, banking and finance links and resources, and a suite of applications tailored to members' specific risk-management and end-to-end contract execution needs. The system also provides access to shipping related services such as freight brokerage, direct booking for liner transport, load and discharge supervision and laboratory testing.

U.S. Pat. No. 8,849,711 pertains to a graphic user interface is disclosed that combines a traditional trading, bookkeeping system or clearing system window with a detailed margin and/or collateral asset calculation analysis window on a single screen. The disclosed GUI provides the flexibility to analyze any combination of products or instrument classes such as single stock futures, futures (of all types), options (of all types), forward contracts, security options, securities and cash-based assets. Conventional systems merely block entry of orders beyond a predetermined credit limit or display clearing/bookkeeping information on all types of portfolio or accounts. The disclosed GUI, in an automated real-time or manual execution control basis, provide the user useful information (all types of numerical and/or graphical display) concerning which products contribute to and how much each product position contribute to the margin limits on, for example, multiple levels; all types of product level, product period (duration) level, account level and clearing level, etc. In one embodiment, the margin window may include a “what if” Scenario Panel and an “Actuals” Margin Analysis Panel. This Scenario Panel allows the user to experiment with “what-if” scenarios in real time or on an as-needed basis. This allows the user to better assess the changes an “actual” position(s) or “what-if” position(s) may have on the margin requirements on all account level types. Further, the actual panel displays the account's actual positions and the associated contributions each position has to that account's margin requirements.

United States Patent Publication No.: 2014/0006244 pertains to methods and systems for acquiring private financial data from multiple disparate sources. The private financial data is normalized, aggregated, preferably enhanced, and stored in secure storage. Entitled entities may retrieve selected private financial data from that secure storage efficiently, flexibility, and rapidly. Examples of financial private data include non-liquidity destination related sources of private data as well as liquidity destination related sources. A non-limiting example of a computer-implemented, consolidated, private financial data service is based on a secure, permission-based, aggregated and consolidated data cloud, which enables provision/distribution to one or more authorized parties with legitimate interests selected portions of the consolidated, private financial data.

United States Patent No.: 2014/0136389 pertains to a calendar spread futures contract is a forward contract on the intermonth spread of futures contracts. The calendar spread futures contract can be independently traded and accounted for independent of the traditional roll periods of the complementary futures contracts. An open interest holder can hedge against price volatility in the related futures contracts that may occur prior to or during the roll period. In other words, the calendar spread futures contract locks in the current spread between the front-month contract and the first-deferred contract. Buying a calendar spread futures control is equivalent to buying the spread difference between the expiring contract and the second expiry. Selling a calendar spread futures contract is equivalent to selling the spread difference between the expiring contract and the second expiry.

Data is created in a number of ways in the modern trading world. Pre-trade data is composed of bids and offers representing liquidity, either resting in an order book, or on the market as bid or offer, or implied by a relationship to another market across multiple platforms. Once pre-trade data has been transacted it become post-trade data. Post trade data is disseminated from the venue on which it has been transacted to clearing members who in turn disseminate same post trade data to clients in real time and or near real time. These post trade data originate from trading and transaction forums globally in many nations representing hundreds of products and hundreds of clearing entities. Spectra aggregates these data into a single common electronic repository, translating symbology, variable types of price display or arithmetic expressions without limit to number or type of data source. Clearing members are competitors for the same pool of clients. They do not share post trade data. The present invention is a neutral application that aggregates a client's data from multiple venues and through multiple clearing members and or counterparties without limit to source or product. The present invention is the linkage between clients with multiple relationships and a real time consolidated view of their trading which cannot be produced without aggregation of post trade data.

The term “near real-time” or “real-time” (NRT), refers to the time delay introduced, by automated data processing or network transmission, between the occurrence of an event and the use of the processed data, such as for display or feedback and control purposes.

### SUMMARY OF THE EMBODIMENTS

The present invention provides for a system for aggregating financial data comprising: memory that stores computer-executable instructions; a processor, communicatively coupled to the memory that facilitates execution of the computer-executable instructions; said instructions comprising: a transformation engine: said transformation engine adapted and configured to transform said financial data into a plurality of information; and a computation engine, said computation engine adapted and configured to compute a realized profit and loss statistic from purchase and sale data; and a plurality of databases; wherein said financial data is stored prior to transformation by the transformation engine; and a reporting engine; said reporting engine adapted and configured to create a plurality of reports according to a report configuration and report filter definition table; and an aggregation engine, said aggregation engine adapted and configured to collect financial data from a plurality of entities and which transforms financial data from a plurality of entities into a consolidated view of client positions and transactional activity.

Further, the present invention also provides for a method for aggregating financial data, the steps of which comprise; memory that stores computer-executable instructions; transforming, via a transformation engine said financial data into a plurality of information; and computing via a computation engine a realized profit and loss statistic from purchase and sale data; and storing via a plurality of databases; wherein said financial data is stored prior to transformation by the transformation engine; and creating, a reporting engine a plurality of reports according to a report configuration and report filter definition table; collecting, via an aggregation engine financial data from a plurality of entities; and transforming, via an aggregation engine, data from a plurality of entities into a consolidated view of client positions and transactional activity.

Generally, the present invention provides for the ability to perform futures clearing data consolidation. That is, the consolidations of a user's accounts across multiple clearing brokers, consolidating client data across multiple clearers are also performed. With this information intra-day futures position and realized profits and losses are calculated. Ideally, commodity trading advisors, fund managers, and account holders alike will be able to access and view their account data intraday, and view them within a flexible, customizable view showing trades, positions, balances and collateral holdings. This allows individual brokers to provide their clients with online access to account details with varying levels of granularity currently. The present invention also does that but aggregates clients data across multiple clearing brokers. This provides the benefit of allowing a broker to have manipulatable access to a given client's information across multiple clearers.

A system and method for aggregating post trade financial data having a transformation engine to transform said post trade data into a plurality of information; and a computation engine to compute a realized profit and loss statistic from purchase and sale data; and a plurality of databases; wherein said post trade data is stored prior to transformation by the transformation engine; and a reporting engine to create a plurality of reports according to a report configuration and report filter definition table; and an aggregation engine to collect post trade data from a plurality of entities and which transforms post trade data from a plurality of entities into a consolidated view of client positions and transactional activity.

It is an object of the present invention to provide a means to consolidate futures.

It is an object of the present invention to provide a tool to visualize investments across a number of brokerage houses.

It is an object of the present invention to provide intraday futures positions.

It is an object of the present invention to calculate realized profits and losses in real time and/or near real-time. It is an object of the present invention to calculate open trade equity.

It is an object of the present invention to provide a real-time net liquidation value calculation.

### BRIEF DESCRIPTION OF THE DRAWINGS

FIG. 1 shows a deployment models for the present invention.

FIG. 2 shows an embodiment of the request offset screen of the present invention.

FIG. 3 shows an illustration of how a user gets a consolidated view of their activity by using the present invention.

FIG. 4 shows a chart showing an embodiment of the structure of customer information.

FIG. 5 shows a chart showing an embodiment of user to account relationships.

FIG. 6 shows an embodiment of the relationship between desk, traders, and sales codes of the present invention.

FIG. 7 shows an illustration of the intraday processing components of the present invention.

FIG. 8 shows an illustration of entitlement levels control data access of the present invention.

FIGS. 9A-9D show various embodiments of the navigation menu of the present invention.

FIG. 10 shows an embodiment of the raise query screen of the present invention.

FIG. 11 shows an embodiment of the common filter for home page and dashboard panels of the present invention.

FIG. 12 shows an embodiment of the Position Summary and Detail screen of the present invention that is used to show consolidated position data.

FIG. 13 shows an embodiment of the trade level functions of the present invention.

FIG. 14 shows one embodiment of the Wire Request and Cancel Wire Request screens of the present invention.

FIG. 15 shows one embodiment of the Pre Advise Request and Cancel Pre Advise Request screens of the present invention.

FIG. 16 shows one embodiment of the Check Request and Cancel Check Request screens of the present invention.

FIG. 17 shows various functions available on one embodiment of the balance screen of the present invention.

FIG. 18 shows an embodiment of the statement quick filter, review and download screens of the present invention.

FIG. 19 shows a screen for setting up different levels of messages for users to view in the News and Information panel on the home page of the present invention.

FIG. 20 shows an alternative embodiment of the home page structure of the present invention.

FIG. 21 shows an alternative embodiment of the home page layers of the present invention.

FIG. 22 shows an embodiment of the dashboard page structure of the present invention.

FIG. 23 shows an embodiment of the dashboard page layers of the present invention.

FIG. 24 shows an embodiment of the balances screen of the present invention.

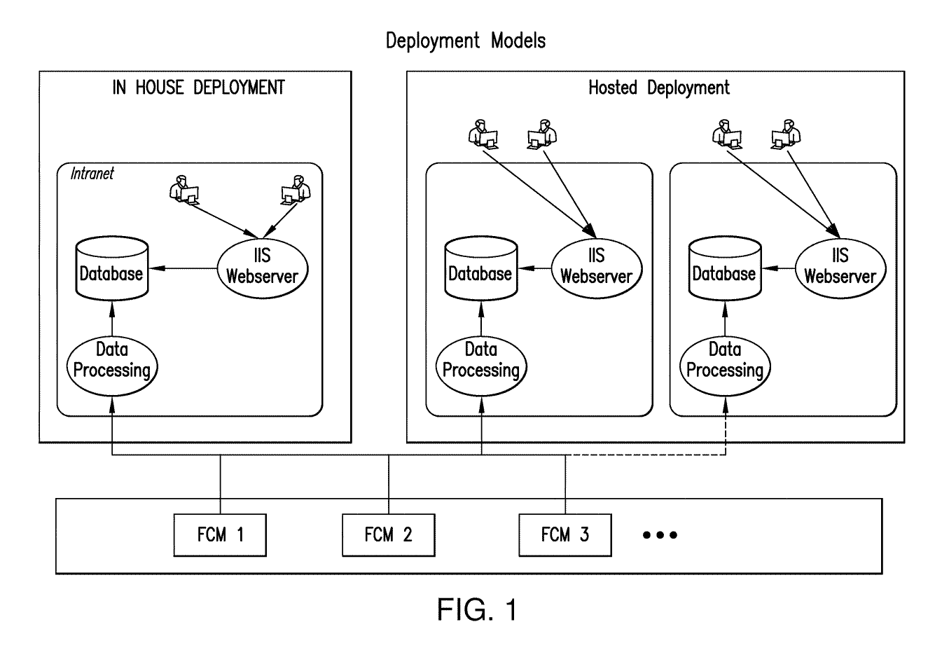

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

In one embodiment of the present invention, the system is capable of taking transactional futures data from any number of clearing member firms by account and transforming the data into information. Specifically, users will be provided with near real-time trade and position reporting, historical trade, position, balance and collateral reporting for the account(s) since inception, comprehensive and flexible reporting, adaptive profits and losses tracking; customized daily reports to track commissions, fees, brokerage and volumes, and historical daily, monthly and 1099 statements for the account(s). Preferably, the real-time trade and position reporting will be refreshed as frequently as providers of the data can accommodate. The present invention combines data acquisition and data processing tasks, normalizes data from multiple sources into a proprietary format and then presents the data through aggregated and granular forms to users via a simple browser based interface that does not overwhelm users. It does this for several clearers and in addition adds on a client driven on-demand reconciliation to clearer data. By providing access to data in several forms with ability to export to excel, provide capability to filter data using different fields, the task of reconciliation and data analysis is simplified and presents opportunities for efficiency.

Many embodiments of the present invention use the following methodology in computing realized P&L based on available data from the clearer, assuming that Purchase and Sale (P&S) records are available. Here, realized P&L is calculated simply as:

Realized P&L=ΣPrincipal where records are P&S Records

The present invention is also capable of performing Open Trade Equity (OTE) calculations. These calculations are based on the following data elements:

(1) ClosingPrice—Closing Price of a Security on a given day

(2) TradePrice—Trade price on the trade

(3) Quantity—Quantity or number of contracts

(4) Multiplier—standard multiplier for the given trade—usually driven by the type of contract

When trade is a Buy: OTE=(ClosingPrice−TradePrice)×ABS(Quantity)×Multiplier

When trade is a Sell: OTE=(TradePrice−ClosingPrice)×ABS(Quantity)×Multiplier

In addition to the above functionality, the present invention is also capable of performing net liquidation value (NLV) calculations. NLV is calculated based on the following data elements:

CashBalance—this is the previous day close of business cash value in account

OTE—Open Trade Equity as calculated above

LongOptionValue—Current Long Option Value based on latest prices

ShortOptionValue—Current Short Option Value based on latest prices

RealizedPnL—Latest realized P&L as calculated above

Here, the current NLV is calculated as follows:

NLV=CashBalance+OTE+LongOptionValue−ShortOptionValue±RealizedPnL

The present invention has several data processing and flow components, such as: (1) database; (2) overnight data processing; (3) intraday data processing; (4) presentation portal.

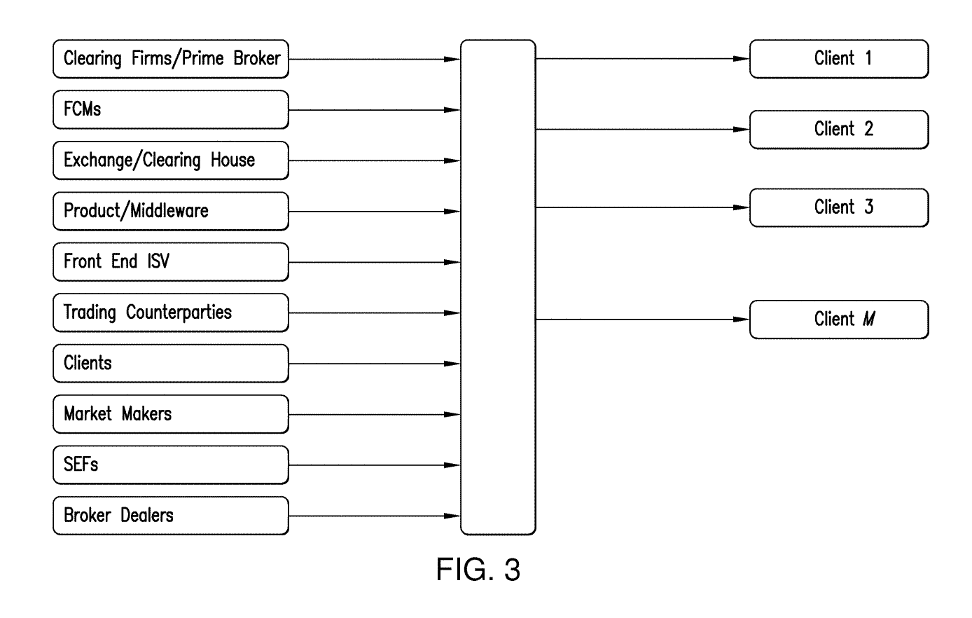

Referring to FIG. 3, of how a user gets a consolidated view of their activity by using the present invention is shown. Data used by the present invention is organized across multiple databases as follows:

configdb—this database holds various configuration tables along with user and user password information;

refdb—this databases holds various referential static data such as accounts, exchanges and products;

etldb—this database is used as a staging area for all Extract, Transform and Load (ETL) operations in the present invention;

traxdb—this database houses the primary transactional data in the present invention.

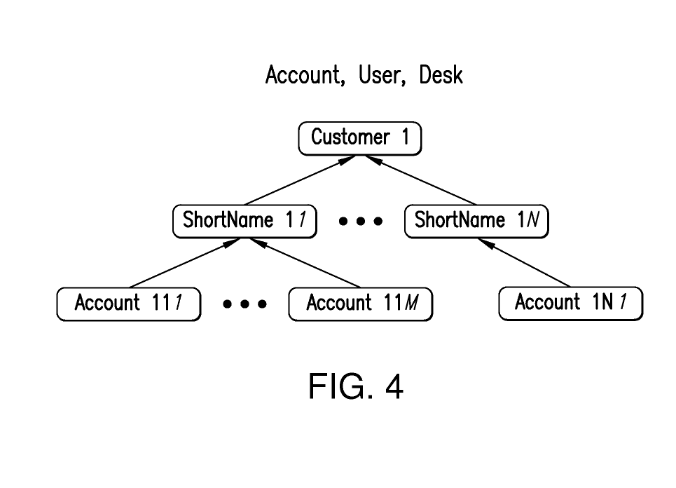

FIG. 4 shows a diagram illustrating an embodiment of the structure of customer information.

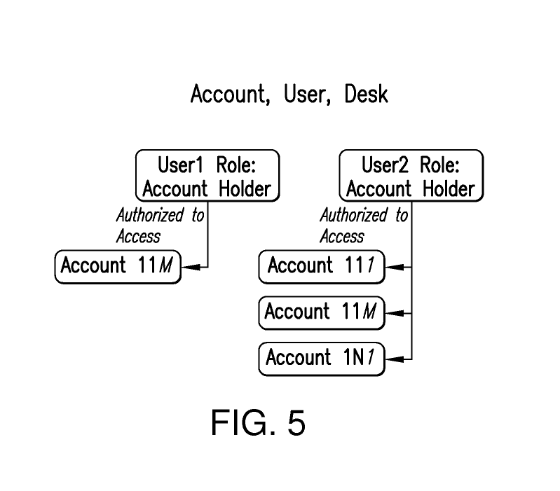

FIG. 5 shows a chart showing an embodiment of user to account relationships.

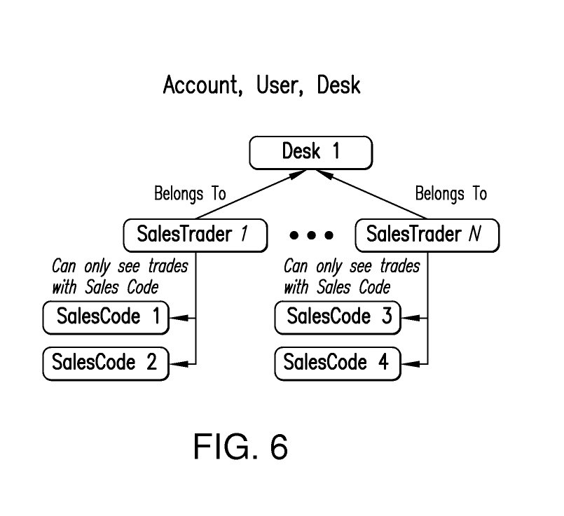

FIG. 6 shows an embodiment of the relationship between desk, traders, and sales codes of the present invention.

In a preferred embodiment, the present invention uses the Microsoft SQL Server Reporting Services (SSRS) infrastructure to produce different reports. SSRS is configured to connect to the SQL Server using a standard functional user id. Reports are designed using the Visual Studio reports designer and the report definitions are subsequently deployed to the reporting server. An additional beneficial feature is that new reports can be made available to users without a full software release, reducing the risk of instability in the system and significantly enhances turnaround time for users. The reporting process works as follows:

(1) When a user goes into the reporting page, the present invention requests the list of reports for the user; (2) then a list of reports and the associated filters are returned and rendered on the reporting page; (3) from that point, a user clicks on a report, selects filter criteria and clicks on RUN to request a report; (4) the reporting serve then runs required queries and obtains data from database; and (5) returns formatted data to the users browser

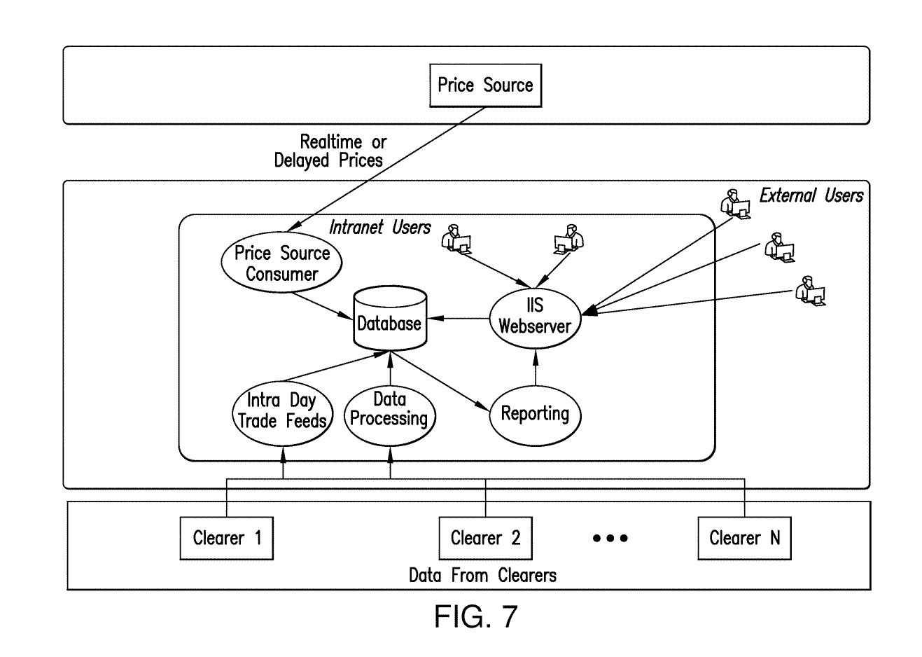

Referring to FIG. 7, a picture showing an embodiment of intraday processing components of the present invention is provided.

In various embodiments, batch processing in the present invention is managed via a combination of two tools which are connected to the SQL Database Server. Such tools include: SQL Server Integration Services (SSIS)—this is used to build the logical data processing flow for all batch processing. Functions cover everything from parsing incoming files, updating tables, or moving files around as needed; SQL Agent—this component of Microsoft SQL Server is used for handling scheduling of jobs; The Job details are created as SSIS Scripts and stored on a filesystem; and The Job Scheduling is configured in the SQL Agent which stores the configurations on the database server. Preferably, the SQL agent reads the configurations from the database, pulls up the corresponding JOB detail in the SSIS Script and invokes SSIS (SQL Server Integration Services) to run the jobs; and the SQL Agent/SSIS access the database to perform operations.

Regarding trade data, Clearers or other data providers will need to provide trading/transactional data overnight into the present invention via FTP. This data is then loaded into a table in the etldb database and then runs post load steps to enrich and convert the data into a proprietary standard format. This data is then processed into trade tables in traxdb database.

Regarding position data, Clearers or other data providers will need to provide position data overnight into the present invention via FTP. The present invention then loads this data into a table in the etldb database and then runs post load steps to enrich and convert the data into a proprietary standard format. This data is then processed into position table in traxdb database. Regarding balance data, Clearers or other data providers will need to provide daily balance data overnight into the present invention via FTP. The present invention then loads this data into a table in the etldb and then runs post load steps to enrich and convert the data into a proprietary standard format. This data is then processed into money tables in traxdb. For collateral data, Clearers or other data providers will need to provide collateral holding data overnight into the present invention via FTP. The system then loads these into a table in the etldb and then runs post load steps to enrich and convert the data into a proprietary standard format. The data is then processed into trade tables in traxdb. Referring to exchange/product data, Clearers or other data providers will need to provide

Exchange rates data overnight into the system via FTP. The system then loads these into a table in the etldb and then loads them into an exchange rates table in refdb.

Users of the present invention are provided access by an administrator user who is setup at installation time. Users will receive an email with a temporary password which they must then use to login and select a new password. User can be setup as a TRADER in SPECTRA but may not have a login. Recovering a forgotten password can be done by the user by simply clicking on the ‘Forgot password’ link on the login panel. If a valid email is on record for this user, a temporary password will be emailed to the user. If not, user has to call the administrator for a password every time a new password is selected for the user, its Days to Expiry on the password gets reset to a number of days that is configurable in the system—but is typically set to 60 days. Once the password expires, user will be forced to select a new password. Users who do not use the login provided to them within 60 days or have a 60 day inactivity period, will have their logins deactivated.

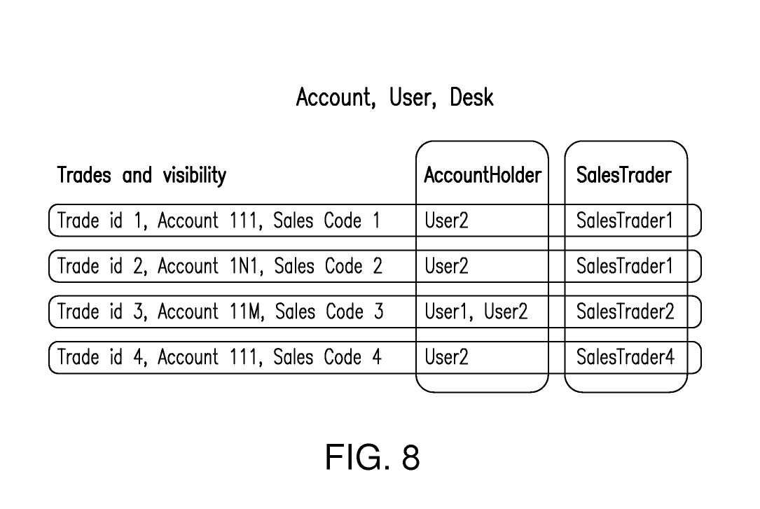

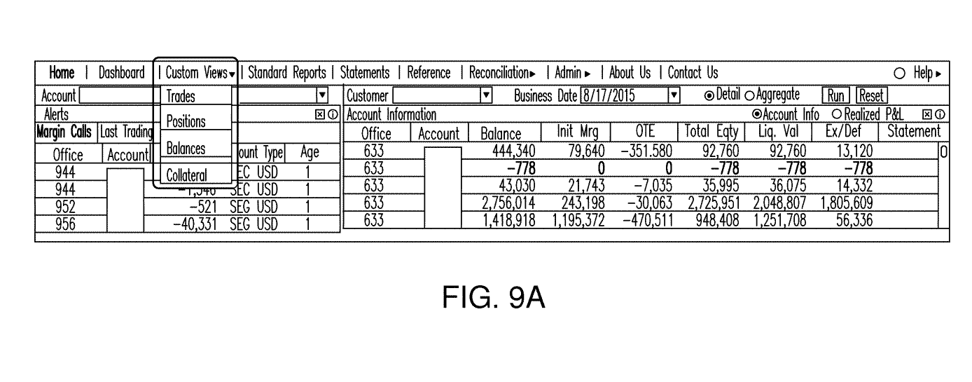

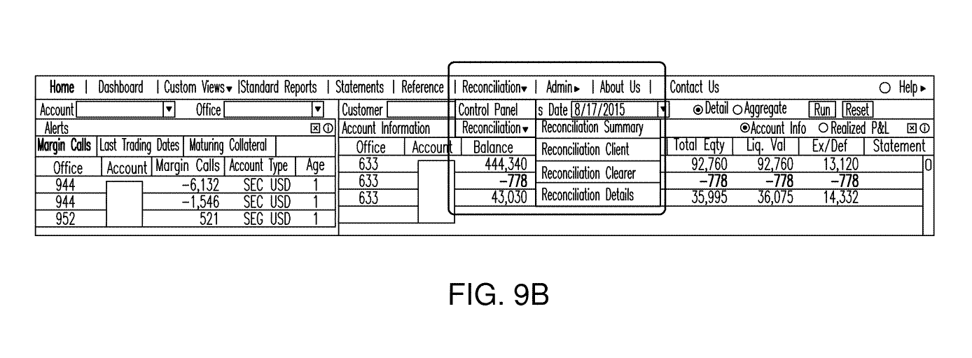

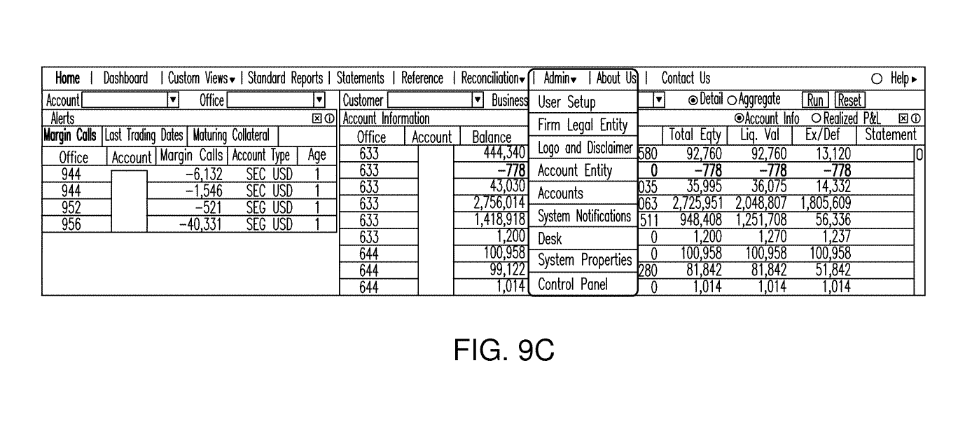

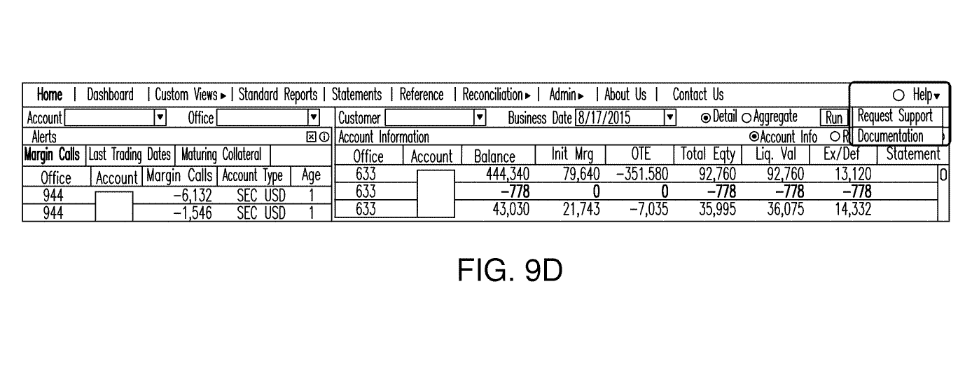

The Navigation menu of the present invention, as shown by FIGS. 9A-9D, comes from a database configuration table. This is combined with user entitlement, shown by FIG. 8, to ensure only the permitted menu entries are accessible to user. In a preferred embodiment, the home screen is organized into multiple panels. Common features to all the panels are as follows: panels that show data have ability to export to Excel; all panels have an INFO icon to get a summary about the panel; and all panels that show data will be filtered based on the filter criteria specified in the filter row.

In a preferred embodiment, the system of the present invention is capable of generating alters. Such alerts include: Margin calls that are outstanding are displayed in this panel along with the Margin call's age; Last Trading Dates which show the last trading dates of products traded in the accounts. The panel shows those products that have their last trading dates coming up in the next 20 days; Maturing Collateral which shows any collateral that is held in the accounts that have expiration dates in the future with respect to the current business date, will be listed in this panel; Account information panel which shows the balance on the account along with other information: Initial margin, Open Trade Equity (OTE), Total Equity, Liquidating Value, and Excess Deficit; Daily and Cumulative P&L which shows daily realized P&L for past 30 days up to and including previously closed business date—this is displayed as a column chart with red columns showing a loss and blue columns indicating a gain and Daily cumulative realized P&L for past 30 days—this is displayed as a continuous line graph. Additional alerts for news and information, such as an RSS feed, and various system information

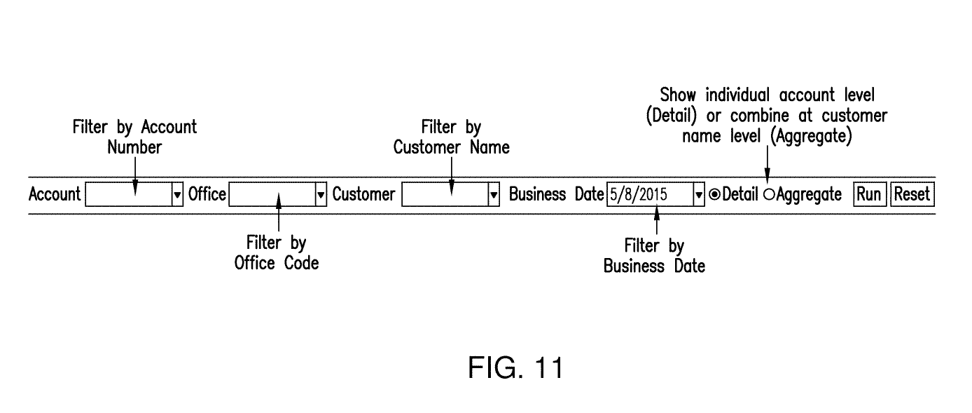

In another preferred embodiment, the dashboard page of the present invention is organized into multiple panels of information as described in subsections below. The filter capability in FIG. 11 allows clients to view their position and balance data as of a particular business date that can be any day in the past for which data was received in the system. There exists a positions panel, which shows the positions in the account and is grouped by Product and

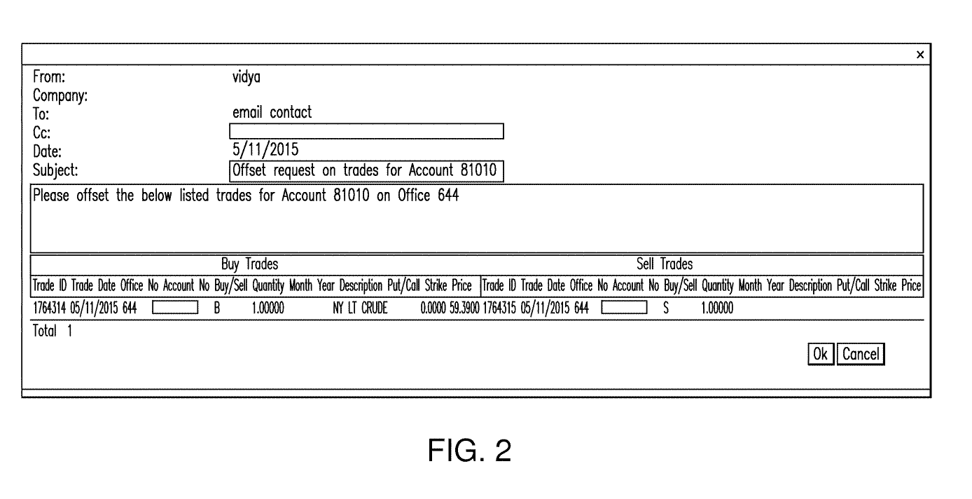

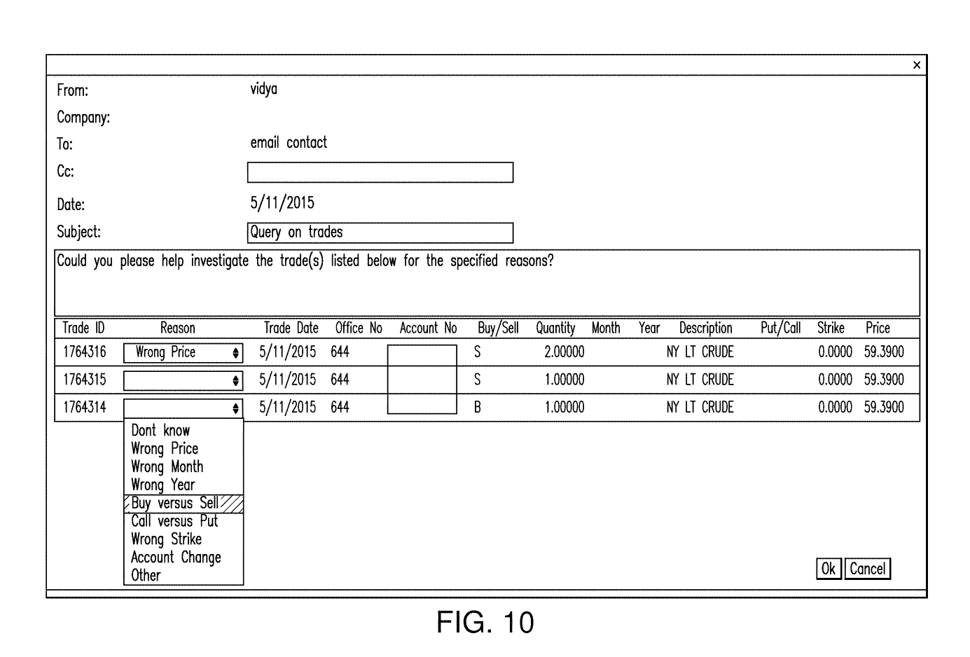

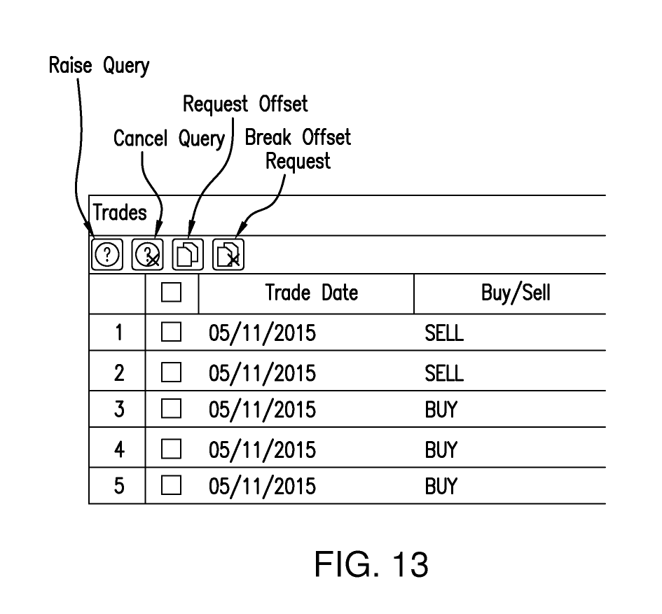

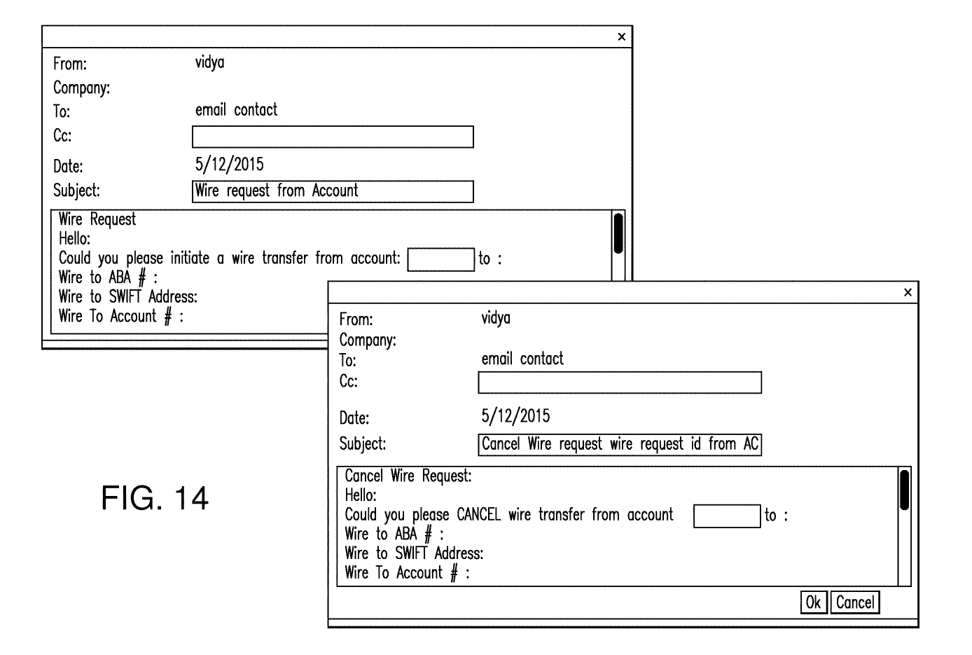

Account type. The positions shown combine close of business previous business date positions with positions resulting from intraday trading activity. The information shown in the balance panel is the same as that in the Account information panel in the Home page except that this does not show links to statements. There is also a panel that shows an aggregated realized P&L. The data is presented in up to 5 columns: YTD—represents the realized P&L Year to Date; QTD—represents the realized P&L Quarter to Date; MTD—represents the realized P&L Month to Date; T-1—Represents the realized P&L the previous business date; T—Represents the realized P&L for the current business date. Clicking on the Column label at the bottom or the value that is next to the column will allow a drilldown into a view that shows the different products that contributed to the P&L. Positive Realized P&L is represented by a Blue font and a Negative realized P&L is represented by a Red font. On the raise query screen, shown by FIG. 10, selecting a Reason and clicking on OK results in an email being sent out to a previously configured email id. Similarly, clicking on Cancel Query, on the trade custom view, illustrated by FIG. 13, on a selected set of trades will result in a request to ignore a previously raised query. There exists a Request Offset function, shown by FIG. 2, which is implemented to allow users to request sets of buy and sell trades to be paired off as a tax lot. The Break Offset function does the opposite which is request for the offset group to be broken up. Trades with Offsets are linked by an Offset Id.

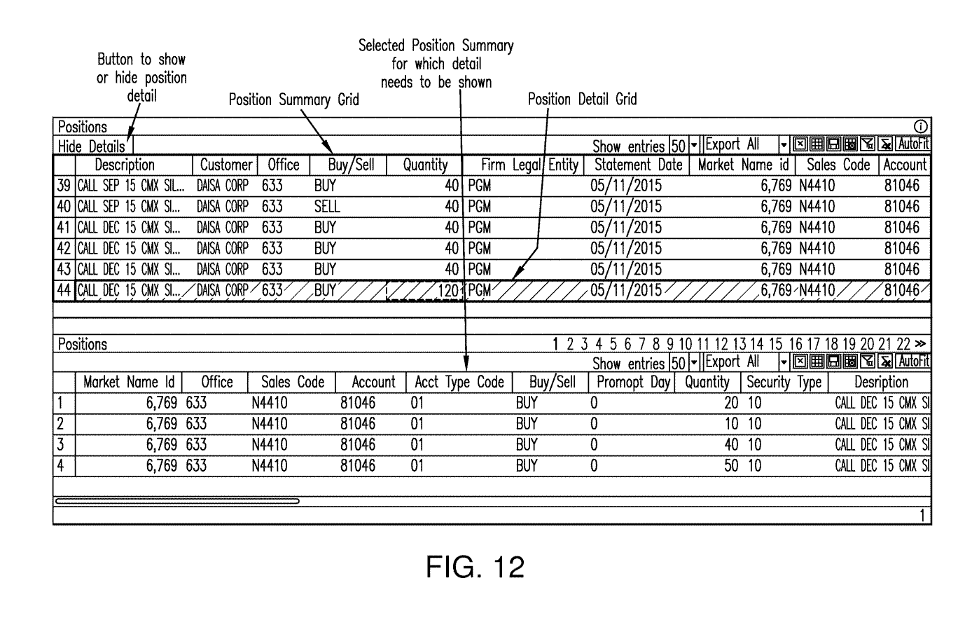

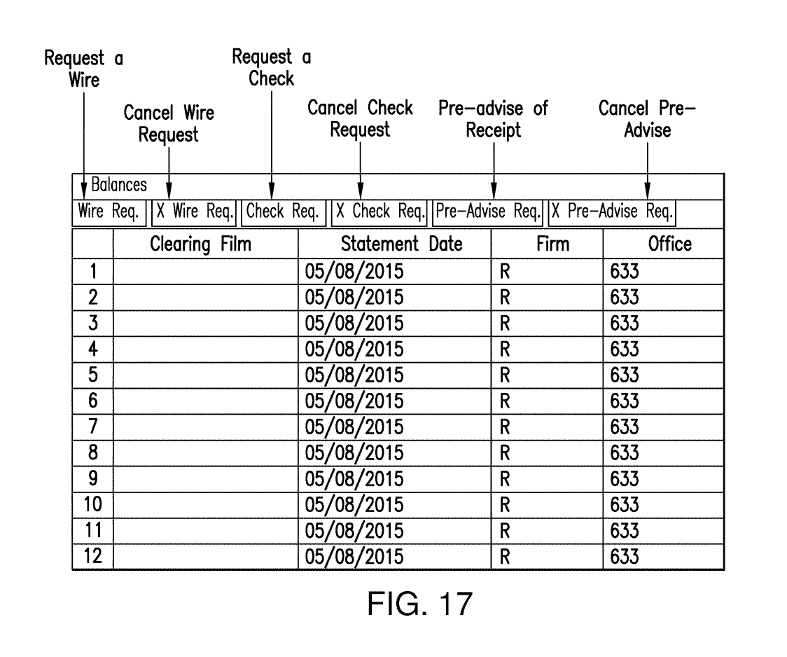

A Position Summary and Detail screen is shown by FIG. 12. These position screens present the view into consolidated position data across multiple data sources to clients. Here, the position custom view contains two grids. When the view is initially launched, it will present a summary of positions. Users can click on any of the rows and then click on the ‘Show Details’ button to see the underlying details that make up a particular position. The position detail grid supports the same grid functions as the summary grid and can be customized and saved for each user as well. Further, the balance custom view, shown by FIG. 17 of the present invention can be used to query for various balance details at office, account, account type, customer name level.

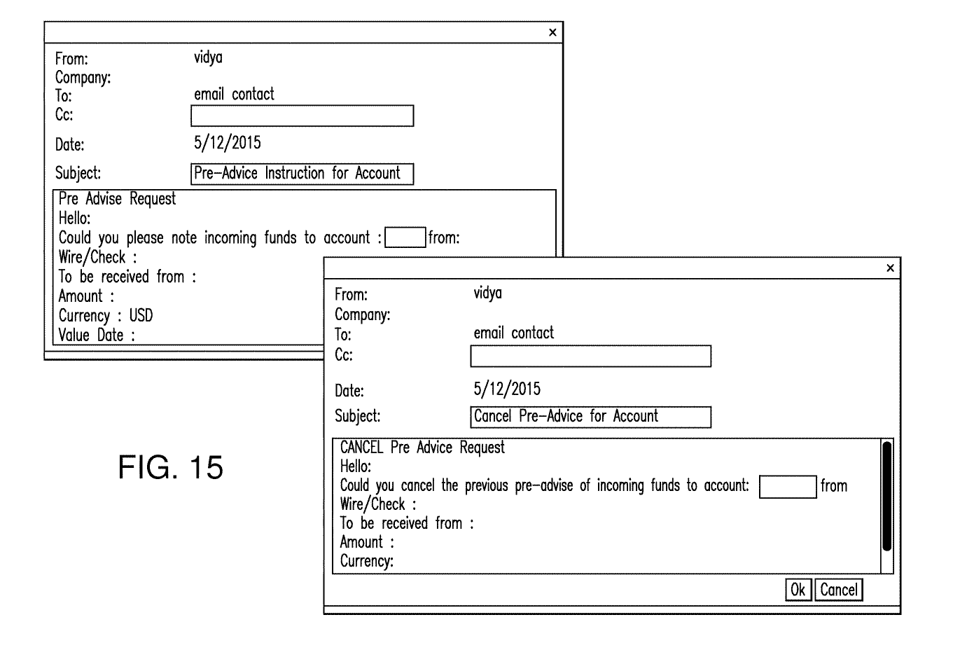

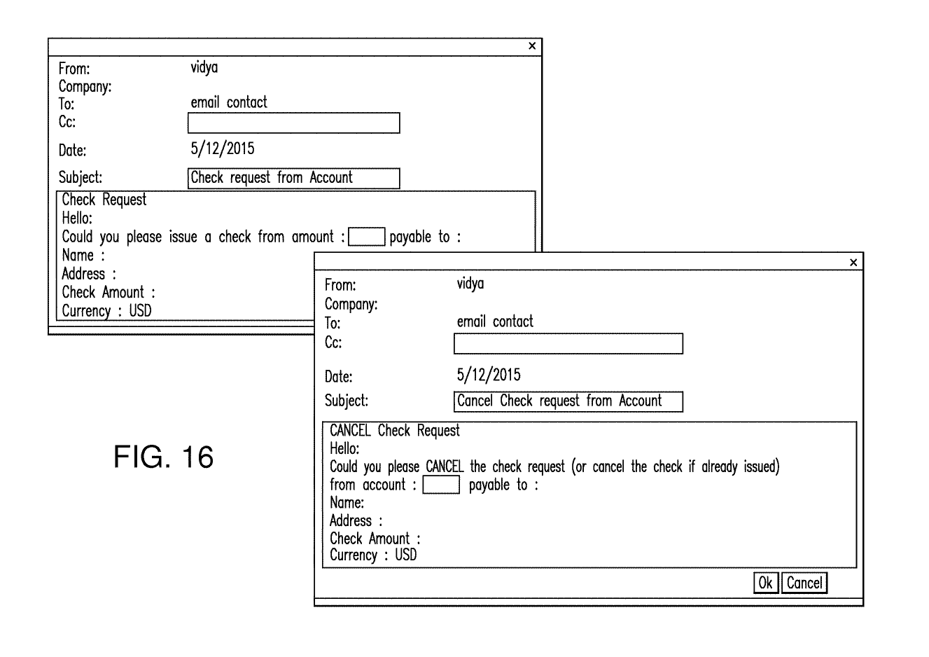

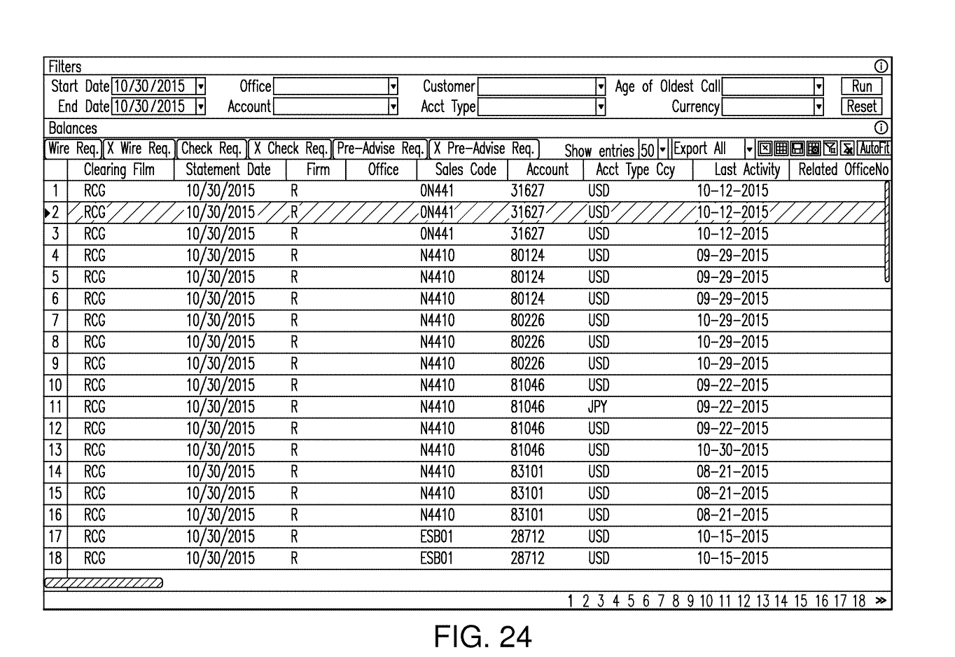

The present invention also provides for a Wire Request, X Wire Request screen where a user can select ONE row on the balance screen and click on the Wire Request or Cancel Wire Request buttons to get a popup. User needs to fill required details on the popup and click on OK. At this point, an email is sent to the email id listed next to the “To” label for further action. Additionally, there exists a Check Request, X Check Request screen where a user can select ONE row on the balance screen and click on the Check Request or Cancel Check Request buttons to get a popup as shown. User needs to fill required details on the popup and click on OK. At this point, an email is sent to the email id listed next to the “To” label for further action. Also, the present invention has a Pre-Advise Request, X Pre-Advise Request screen where a user can select ONE row on the balance screen and click on the Pre-Advise Request or Cancel Pre-Advise Request buttons to get a popup as shown in FIG. 15. User needs to fill required details on the popup and click on OK. At this point, an email is sent to the email id listed next to the “To” label for further action. Additionally, there exists a collateral screen, which will show only those records that are classified as collateral. This would mean that products like bonds and other products that are classified as ‘Receipts’ will also show up on this screen. Standard Quick Filter and Grid Filter functions are available on this custom view as well. There also exists a balance custom view, shown by FIG. 24, where a user may query various balance details at office, account, account type, and customer name levels.

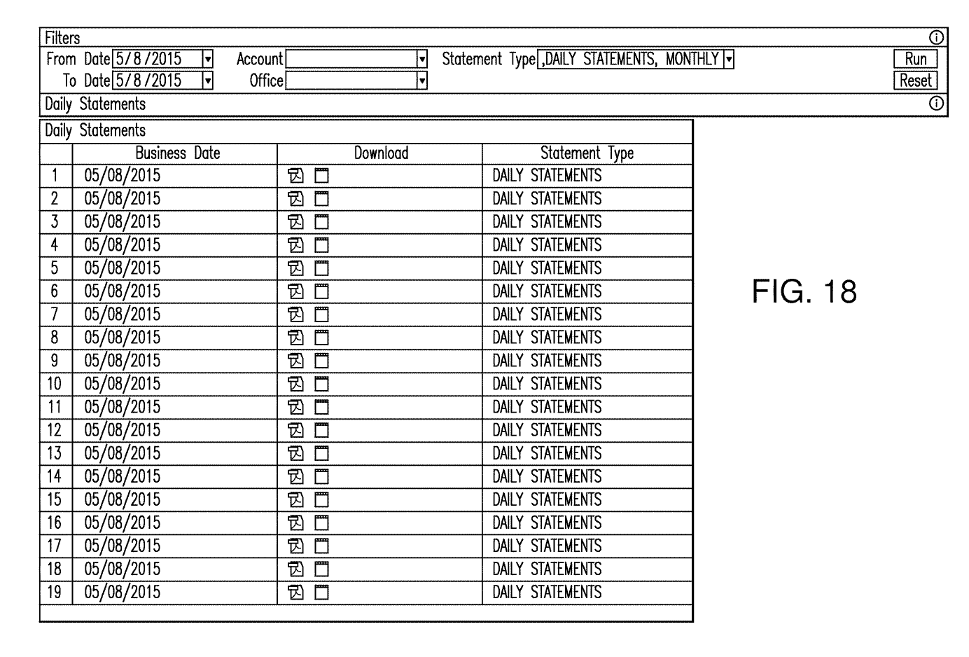

FIG. 18 also shows a statements summary screen where client statements from the clearer are parsed out into individual client accounts and made accessible through the Statement screen. Users can filter for accounts, office codes or type of statements. Preferably, the system will extract and load daily statements, monthly statements, and 1099 forms. The present invention also has a reporting page, which consists of 3 components. First is the Report Explorer component. The Report Explorer displays available reports that user is entitled to in a Windows Explorer like format. The organization of the reports can be customized for a particular installation. The intent of the Top level nodes is to allow for grouping together of similar types of reports and this make navigation easier. A top level node can have another ‘sub’ top level node. Actual reports that users can click on and execute are at a leaf level. Second is the report filter component. Clicking on a leaf level node in the Report Explorer populates the Report Filter Selector. This also enables or disables certain report criteria based on the selected report. These are all configured in the system's database. Once appropriate filter selections are made, user clicks on RUN to execute the report. The third component is the Report Viewer. Clicking on RUN in the Report Filter Selector panel will launch the report in the Report Viewer. User can review the report online in the Report Viewer. In addition, user can save the report to Excel (suggested) format.

A set of administration functions are available in various embodiments of the present invention. For example, a Firm Legal Entity may be designated. While this will be used for initial setup, it is used to establish contact information including email for a firm using the present invention. If the firm has multiple legal entities, they can all be setup using this screen. There is also a Desk manager screen which can setup desks in the system and once this is done, associate users with a given desk. Further, though the customer legal entity names are automatically created at data load time, an Account entity screen can be used to create new customer entities and then be referenced in the Account screen to link several accounts to one entity for ease of viewing and report.

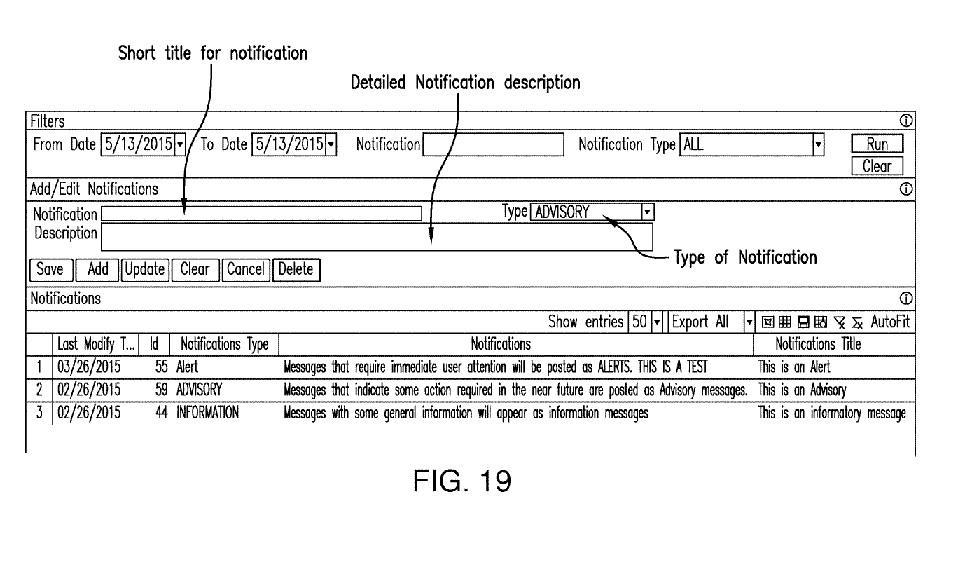

The present invention also features a system information screen, illustrated in FIG. 19. This screen is used by a system administrator to setup messages for users to view on the HOME page under the News and Information panel. The three levels of messages are: (1) ALERT—these are important and urgent messages that users must review and will show up in RED; (2) ADVISORY—these are important information that may require users to take some action and will show up in GREEN; and (3) INFORMATION—these are general information for users and will be in BLUE.

A key aspect of the present invention is its ability to: collect transaction and position data from multiple sources, normalize the data into an internal format, map the different clearing account numbers into appropriate higher level customer entities or customer names, provide a consolidated (aggregated) view of positions that is agnostic to the different sources of transaction and position data, allow Users to drill down to see their data at an account level or chose to see at an aggregate account name level, and Facilitate account managers of multiple accounts to see a combined view of the portfolio of accounts while simultaneously allowing individual account owners to access and view account data.

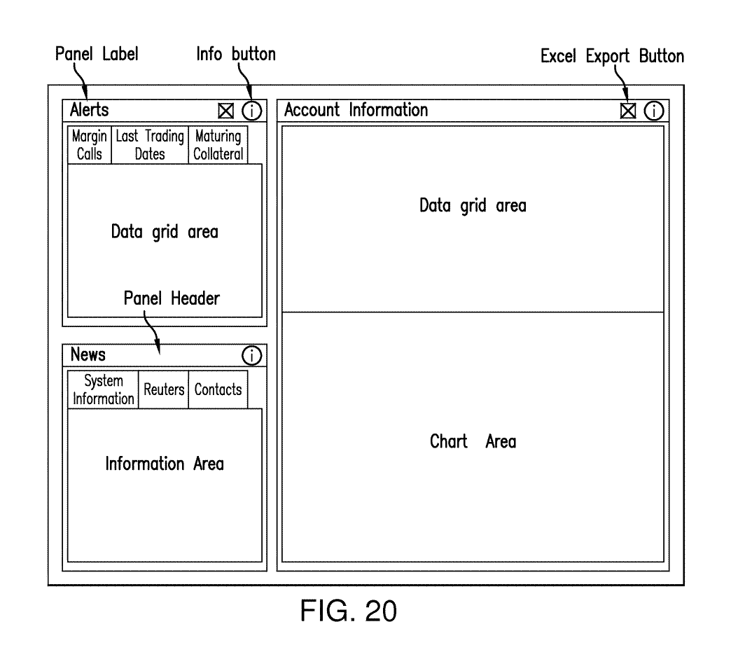

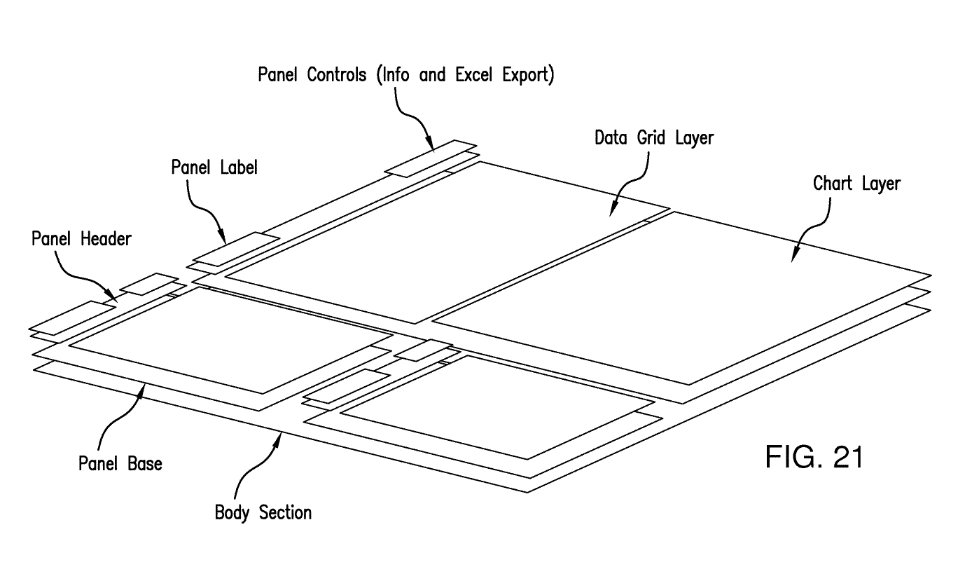

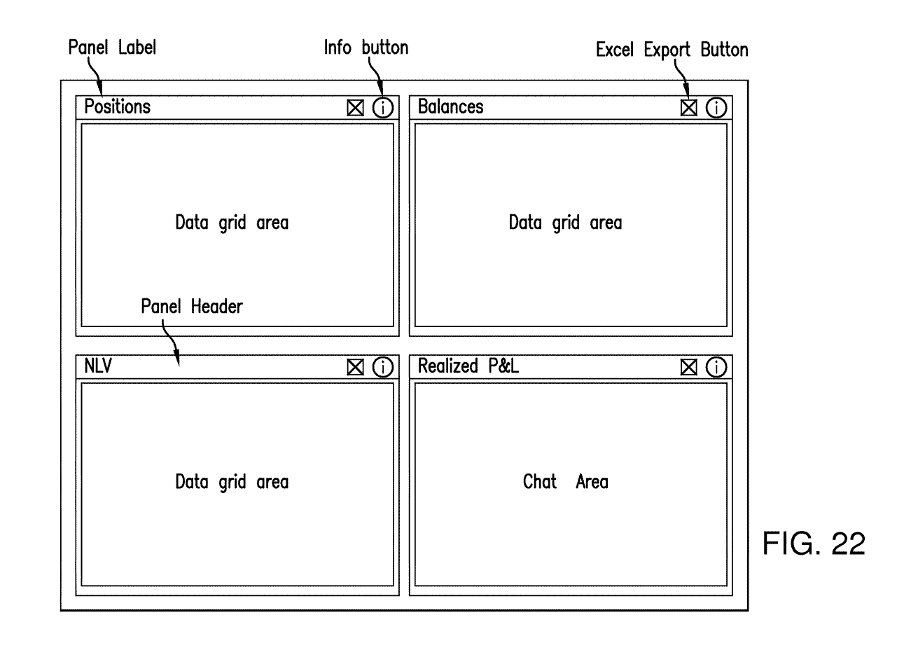

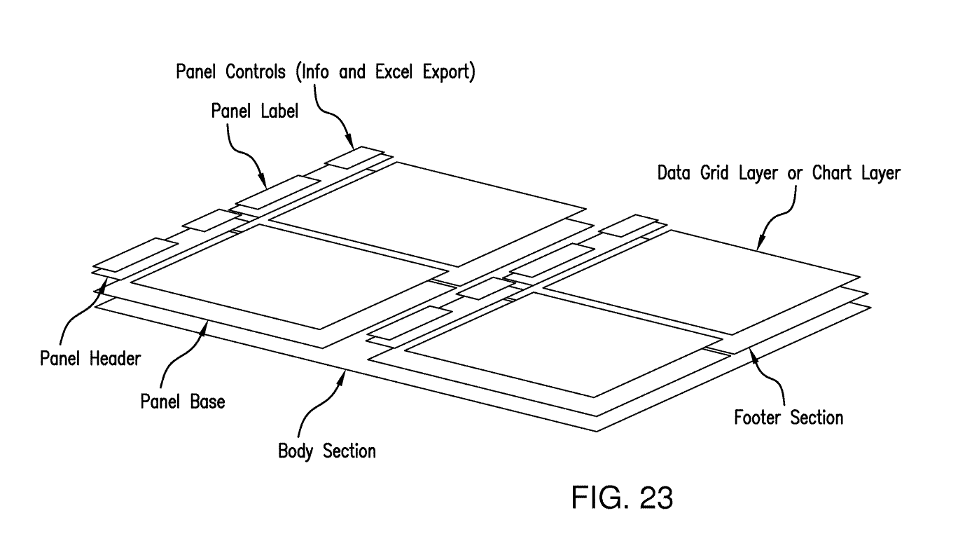

FIG. 20 shows an alternative embodiment of the home page structure of the present invention, FIG. 21 shows an alternative embodiment of the home page layers of the present invention, FIG. 22 shows an embodiment of the dashboard page structure of the present invention, and FIG. 23 shows an embodiment of the dashboard page layers of the present invention. These layers feature a panel header, panel label, panel controls, data grid layer, chart layer, panel base, and body section. These structure feature panel labels panel headers info buttons excel export buttons data grid areas, and information areas.

Typically, a user or users, which may be people or groups of users and/or other systems, may engage information technology systems (e.g., computers) to facilitate operation of the system and information processing. In turn, computers employ processors to process information and such processors may be referred to as central processing units (“CPU”). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with Entities such as, but not limited to: one or more users from user input devices; peripheral devices; an optional cryptographic processor device; and/or a communications network. For example, the present invention may be connected to and/or communicate with users operating client device(s), including, but not limited to, personal computer(s), server(s) and/or various mobile device(s) including-tablet computer(s) (e.g., Apple iPad™, laptop computer(s), notebook(s), netbook(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

### Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

### Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

### Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like.

Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks

(RAID)); solid state memory devices (USB memory, solid state drives (SSD), etc.); other processor-readable storage mediums; and/or other devices of the like. Thus, a computer systemization generally requires and makes use of memory.

### Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

### Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

### Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, User Agents, and/or the like from the enabled nodes of the present invention. The combined application may be nugatory on systems employing standard Web browsers.

### Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), Digital Signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, JSON, NOSQL and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A user (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The user's table may support and/or track multiple Entity accounts. A Client's table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

In a preferred embodiment, the present invention provides a means to consolidate futures, options, foreign exchange, options on foreign exchange, assets and derivatives of assets traded on public exchanges, global markets and capital markets. In another embodiments, the present invention allow a user to visualize investments futures, options, foreign exchange, options on foreign exchange, assets and derivatives of assets traded on public exchanges, global markets and capital markets across a number of brokerage houses. In other embodiments, the present invention provides intraday futures options, foreign exchange, options on foreign exchange, assets and derivatives of assets traded on public exchanges, global markets and capital markets positions.

In yet another preferred embodiment, the present invention can calculate realized profits and losses in real time and/or near real-time futures options, foreign exchange, options on foreign exchange, assets and derivatives of assets traded on public exchanges, global markets and capital markets positions, as well as open trade equity for futures options, foreign exchange, options on foreign exchange, assets and derivatives of assets traded on public exchanges, global markets and capital markets positions.

In some embodiments, the present invention provides a real-time and or end of day net liquidation value calculation and or a net asset value calculation and is capable of consolidating an initial and variation margin requirement view, as well as consolidating views of all exchange data fields, FCM data fields, interbank data field and or vendor data fields. The present invention may also provide a consolidated position view by exchange, by derivative or underlying product, by asset type or currency, a consolidated view across liquidity venues including futures exchanges, OTC interbank counterparties, equity exchanges, hedge funds, FCMs, clearing entities and private liquidity pools, and/or a real time or near real time execution evaluation tool to measure via autofeed various positive and negative attributes and results from order management systems (OMS) and execution management systems (EMS).

In alternative preferred embodiments, the present invention to provides a measurement tool to evaluate accuracy of results from various counterparty and or vendor order management systems (OMS) and execution management systems (EMS) and provides a measurement of timeliness of results from order management systems (OMS) and execution management systems (EMS).

In some embodiments, the present invention can aggregate post trade data, real time data, and near real time data from liquidity venues including futures exchanges, OTC interbank counterparties, equity exchanges, hedge funds, FCMs, clearing entities and private liquidity pools.

In various embodiments, the present invention can aggregate post trade data from liquidity venues including futures exchanges, OTC interbank counterparties, equity exchanges, hedge funds, FCMs, clearing entities and private liquidity pools to provide consolidated trading metrics and performance attributes, as well as doing so for interest payable, due reconciliation, balance reconciliation, position reconciliation, and trade reconciliation.

In one preferred embodiment, the present invention is capable of aggregating post trade data from liquidity venues including futures exchanges, OTC interbank counterparties, equity exchanges, hedge funds, FCMs, clearing entities and private liquidity pools to provide internal and external messaging related to post trade data, as well as real time or near real time compliance alerts.

In other embodiments, the present invention comprises a measurement tool to evaluate best pricing from order management systems (OMS) and execution management systems (EMS) engaging multiple execution venues contemporaneously executing the same or similar orders and is capable of providing a measurement of timeliness of unmatched trade resolution from order management systems (OMS) and execution management systems (EMS).

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof.

Therefore, it is intended that the disclosure not be limited to the particular embodiments disclosed.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. A system for aggregating financial data comprising:
memory that stores computer-executable instructions;
a processor, communicatively coupled to the memory that facilitates execution of the computer-executable instructions; said instructions comprising:
a transformation engine: said transformation engine adapted and configured to transform said financial data into a plurality of information; and
a computation engine, said computation engine adapted and configured to compute a realized profit and loss statistic from purchase and sale data; and
a plurality of databases; wherein said financial data is stored prior to transformation by the transformation engine; and
a reporting engine; said reporting engine adapted and configured to create a plurality of reports according to a report configuration and report filter definition table; and
an aggregation engine, said aggregation engine adapted and configured to collect financial data from a plurality of entities and which transforms financial data from
a plurality of entities into a consolidated view of client positions and transactional activity.

2. The system of claim 1, wherein the plurality of entities further comprises at least one of futures exchanges, futures clearing members, insurance companies, broker dealers, futures commission merchants, clearing members, banks, financial institutions, capital aggregators, technology vendors, and any entity which creates or generates financial data.

3. The system of claim 1, wherein any entity comprises over the counter market makers in foreign exchange, equities, options, exchanged traded funds or other derivative and or primary financial products , banks, or any other source of transactional data in the financial ecosystem whether by open outcry or electronically generated.

4. The system of claim 1, wherein financial data comprises at least one of transactional futures data, data derived from futures exchanges, futures clearing members, insurance companies, broker dealers, futures commission merchants, clearing members, banks, financial institutions, capital aggregators, over the counter market makers in foreign exchange, equities, options, exchanged traded funds or other derivative and or data derived from primary financial products , banks, or any other source of transactional data in the financial ecosystem whether by open outcry or electronically generated

5. The system of claim 1 wherein the web server engine further comprises an application user interface for an external end user.

6. The system of claim 1, wherein the reporting engine provides reports on tracking commissions, fees, brokerage and volume by account, exchange, contract, desk and trader.

7. The system of claim 1 further comprising an archival engine: said archival engine adapted and configured to collect historical trade, position balance and collateral reporting.

8. The system of claim 1 wherein an open trade equity calculation is comprised of at least one of closing price of a security on a predetermined time; trade price of a trade, quantity of contracts, and a multiplier for the instrument traded.

9. The system of claim 8, wherein the multiplier is used when the trade is a buy; such that the trade price is subtracted from the closing price and multiplied by the quantity and the multiplier.

10. The system of claim 9, wherein the multiplier is used when the trade is a sell; such that the closing price is subtracted from the trade price and multiplied by the quantity and the multiplier.

11. The system of claim 1 wherein net liquidation value is calculated based on at least one of cash balance, OTE, long option value, short option value, and realized profit and loss.

12. The system of claim 11, wherein the long option value and the short option value is based on the current prices.

13. The system of claim 1 wherein the plurality of databases further comprising storage for at least one of a user's personal information, static data such as accounts, exchanges and products, extract, transform and load operations, and primary transactional data.

14. The system of claim 1, wherein the realized profits and losses are in real time and/or near real time.

15. A method for aggregating financial data, the steps of which comprise;
memory that stores computer-executable instructions; transforming, via a transformation engine said financial data into a plurality of information; and
computing via a computation engine a realized profit and loss statistic from purchase and sale data; and
storing via a plurality of databases; wherein said financial data is stored prior to transformation by the transformation engine; and
creating, a reporting engine a plurality of reports according to a report configuration and report filter definition table;
collecting, via an aggregation engine financial data from a plurality of entities; and
transforming, via an aggregation engine, financial data from a plurality of entities into a consolidated view of client positions and transactional activity.

16. The method of claim 14, wherein the plurality of entities further comprises at least one of futures exchanges, futures clearing members, insurance companies, broker dealers, futures commission merchants, clearing members, banks, financial institutions, capital aggregators, and any entity which creates or generates financial data.

17. The method of claim 14, wherein any entity comprises over the counter market makers in foreign exchange, equities, options, exchanged traded funds or other derivative and or primary financial products , banks, or any other source of transactional data in the financial ecosystem whether by open outcry or electronically generated.

18. The method of claim 14, wherein financial data comprises at least one of transactional futures data, data derived from futures exchanges, futures clearing members, insurance companies, broker dealers, futures commission merchants, clearing members, banks, financial institutions, capital aggregators, over the counter market makers in foreign exchange, equities, options, exchanged traded funds or other derivative and or data derived from primary financial products , banks, or any other source of transactional data in the financial ecosystem whether by open outcry or electronically generated.

19. A system for aggregating post trade financial data comprising:
memory that stores computer-executable instructions;
a processor, communicatively coupled to the memory that facilitates execution of the computer-executable instructions; said instructions comprising:
a transformation engine: said transformation engine adapted and configured to transform said post trade data into a plurality of information; and
a computation engine, said computation engine adapted and configured to compute a realized profit and loss statistic from purchase and sale data; and
a plurality of databases; wherein said post trade data is stored prior to transformation by the transformation engine; and
a reporting engine; said reporting engine adapted and configured to create a plurality of reports according to a report configuration and report filter definition table; and
an aggregation engine, said aggregation engine adapted and configured to collect post trade data from a plurality of entities and which transforms post trade data from a plurality of entities into a consolidated view of client positions and transactional activity.

20. A method for aggregating post trade data, the steps of which comprise;
memory that stores computer-executable instructions; transforming, via a transformation engine said post trade data into a plurality of information; and
computing via a computation engine a realized profit and loss statistic from purchase and sale data; and
storing via a plurality of databases; wherein said post trade data is stored prior to transformation by the transformation engine; and
creating, a reporting engine a plurality of reports according to a report configuration and report filter definition table;
collecting, via an aggregation engine post trade data from a plurality of entities; and
transforming, via an aggregation engine, post trade data from a plurality of entities into a consolidated view of client positions and transactional activity.
